(19) United States
(12) Patent Application Publication
(10) Pub. No.: US 2023/0394157 A1
(43) Pub. Date: Dec. 7, 2023

(54) UNIFIED LOGGING FOR OPERATING SYSTEMS AND CONNECTED EMBEDDED SYSTEMS

(71) Applicant: Microsoft Technology Licensing, LLC, Redmond, WA (US)

(72) Inventors: Nadav Shlomo BEN-AMRAM, Herzliya (IL); Dmitry BIRENBERG, Rosh-Ha-Ayin (IL); Matan SLASSI, Herzeliya (IL)

(21) Appl. No.: 17/833,848

(22) Filed: Jun. 6, 2022

(51) Int. Cl. G06F 21/57; G06F 21/54; G06F 21/55; G06F 21/60

(52) U.S. Cl. CPC G06F 21/577; G06F 21/54; G06F 21/552; G06F 21/602

(57) ABSTRACT

The disclosure herein describes initializing an embedded system device to send compressed log messages and receiving compressed log messages from the embedded system device. As part of the initialization process, a logger descriptor is requested from the embedded system device via a service interface of the Operating System (OS). The logger descriptor is received from the embedded system device. A logger filter associated with the embedded system device is generated using the logger descriptor and the logger filter is sent to the embedded system device. Then, after initialization of the embedded system device, a compressed log message is received from the embedded system device, wherein the compressed log message is compressed based at least in part on the logger filter. The compressed log message is converted into a readable log message based at least in part on the logger descriptor and the readable log message is inserted into a log associated with the OS.

### BACKGROUND

In the modern landscape of computing devices and embedded systems communicating and/or interacting with each other, collecting and synchronizing logs of various connected devices is performed. In such systems of connected devices, different devices are configured to log data in different ways and the different devices each have their own clocks that are used to timestamp log entries.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for initializing an embedded system device to send compressed log messages and for receiving compressed log messages from the embedded system device is described. As part of the initialization process, a logger descriptor is requested from the embedded system device via a service interface of the Operating System (OS). The requested logger descriptor is received from the embedded system device, wherein the logger descriptor includes data describing log message severity level values, log message group values, log message text strings, log message hash values, or the like. A logger filter associated with the embedded system device is generated using the received logger descriptor and the logger filter is sent to the embedded system device. Then, after the initialization of the embedded system device is complete, a compressed log message is received from the embedded system device, wherein the compressed log message is compressed based at least in part on the logger filter. The compressed log message is converted into a readable log message based at least in part on the logger descriptor and the readable log message is inserted into a log associated with the OS.

### BRIEF DESCRIPTION OF THE DRAWINGS

The present description will be better understood from the following detailed description read in light of the accompanying drawings, wherein:

FIG. 1 is a block diagram illustrating a system configured for obtaining and managing log messages from embedded system devices in a central log;

FIG. 2 is a sequence diagram illustrating a process for initializing an embedded system device for sending compressed log messages to an Operating System (OS);

FIG. 3 is a sequence diagram illustrating a process for synchronizing the clock of an embedded system device with the clock of an OS;

FIG. 4 is a flowchart illustrating a method for initializing an embedded system device for sending compressed log messages and for receiving compressed log messages from the embedded system device;

FIG. 5 is a flowchart illustrating a method for initializing an embedded system device for sending compressed log messages based at least in part on whether a logger descriptor has already been received from the embedded system device; and

FIG. 6 illustrates an example computing apparatus as a functional block diagram.

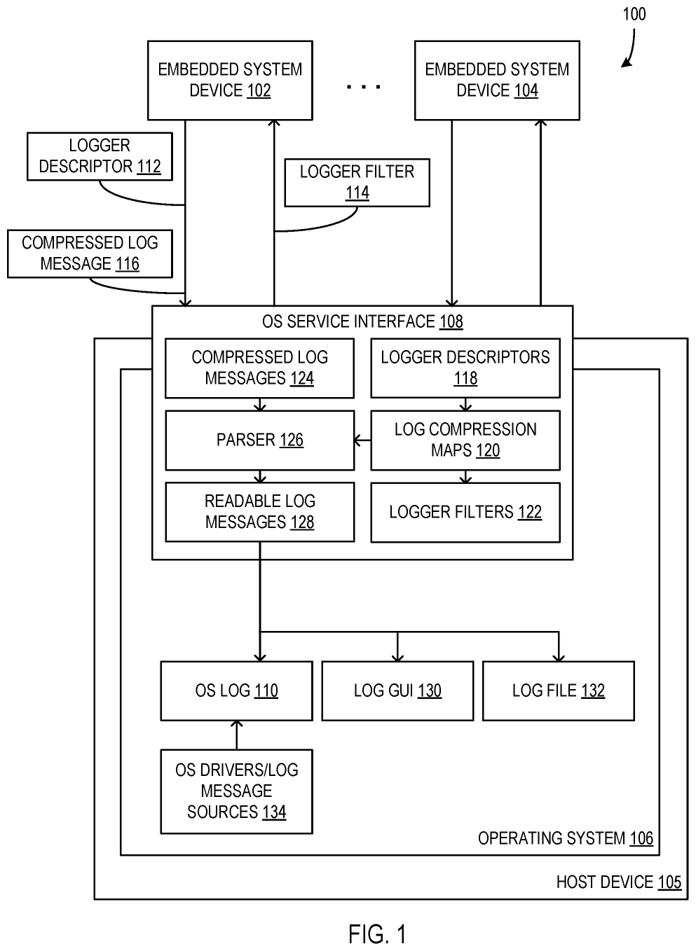

Corresponding reference characters indicate corresponding parts throughout the drawings. In FIGS. 1 to 6, the systems are illustrated as schematic drawings. The drawings may not be to scale.

### DETAILED DESCRIPTION

Aspects of the disclosure provide a computerized method and system for enabling embedded system devices to provide log messages that are then recorded in a central log associated with an OS of a host device. The disclosure describes initializing embedded system devices to enable them to send compressed log messages to the OS of the host device via a service interface thereof. Further, the described initialization process includes obtaining a logger descriptor from the embedded system device and using the information therein to convert compressed log messages from the embedded system device into readable log messages that can be recorded in the log of the OS. Additionally, the described initialization process includes providing the embedded system device with a logger filter that instructs the embedded system device as to what types of log messages to send to the OS via the service interface. After the initialization is complete, the disclosure enables the OS to receive log messages from the embedded system device and record those log messages in a log with other log messages associated with the operations of the OS and/or other log message sources. The disclosure enables challenges associated with systems of connected devices to be addressed, including the challenge of recording log messages of different devices in a consistent way and/or in a common location and the challenge of synchronizing the timestamps of those log messages, despite the devices using different clocks that are otherwise not synchronized with each other during normal operations.

The disclosure operates in an unconventional manner at least by obtaining a logger descriptor from an embedded system device, providing a logger filter to the embedded system device such that it is instructed to send compressed log messages via the service interface, and converting the received compressed log messages to readable log messages based at least in part on the logger descriptor. By initializing the embedded system device to send compressed log messages in this manner, the disclosure enables the OS and associated service interface to receive log messages from many different types of embedded system devices in a consistent manner. Those log messages can be received from those different types of devices at substantially the same time.

Further, the disclosure describes the recording of log messages from multiple embedded devices in a single central log (e.g., associated with the OS of the host device). The disclosure enables these log messages to be synchronized by performing synchronization operations on the embedded system devices, such that the clocks of the embedded system devices are synchronized with the clock of the OS. In some such examples, time data associated with the clock of the OS is provided to embedded system devices in response to time sync requests from those devices and the devices then synchronize their clocks with the OS clock based at least in part on time data. Such synchronization operations are performed when an embedded system device initially connects to the service interface and/or periodically during operation to account for shifting of the embedded system device clock.

Additionally, the disclosure enables the collection of log messages from embedded system devices into a centralized log to be performed efficiently with respect to time and bandwidth usage. The log messages are compressed by the embedded system devices based at least in part on instructions provided by the service interface such that the sending of text strings and/or other portions of the log message are not sent over the connection between the device and the service interface, which reduces bandwidth usage as well as time required for the log message to be sent. Further, the initialization process of embedded system devices is streamlined when a matching logger descriptor is already stored by the OS from a previous initialization. In such examples, the embedded system device is not required to send a complete logger descriptor, which is relatively large and requires substantial time and bandwidth to send.

The disclosure enables the log messages of multiple embedded system devices and other log message sources associated with an OS to be recorded in a single, unified log of that OS in a synchronized manner. Thus, the disclosure enables more efficient, accurate evaluation and/or analysis of log messages to observe events and/or sequences that affect multiple devices.

Additionally, or alternatively, the disclosure enables the log messages from embedded system devices to be sent in a flexible manner. For instance, in some examples, multiple log messages are sent in a single buffer from an embedded system device to the service interface in order to manage available bandwidth therebetween. The determination of how many log messages to send in a buffer may be based at least in part on the size of the log messages and/or the availability of log messages to be sent across multiple embedded system devices that are connected to the service interface of the OS. Thus, the disclosure is configured to avoid overflowing the communication layer of the system through dynamic management of the sending of the log messages.

FIG. 1 is a block diagram illustrating a system 100 configured for obtaining and managing log messages (e.g., compressed log messages 116 and/or 124) from embedded system devices 102-104 in a central log (e.g., the Operating System (OS) log 110). In some examples, the system 100 includes one or more embedded system devices 102-104 that are configured to communicate with a host device 105 upon which the log messages of the embedded system devices 102-104 are obtained and stored as described herein. Further, the system 100 includes an OS Service Interface 108 that is configured to interact with the embedded system devices 102-104 to facilitate the efficient transfer of log messages therefrom.

In some examples, the embedded system devices 102-104 include any peripheral device or other device that connects with a host device 105 and communicates with the connected host device 105. For instance, in some such examples, the embedded system devices 102-104 include BLUETOOTH devices such as pen or stylus devices that are used to interact with the host device 105, headphones or other media devices that enable users to interface with the host device 105 in some manner, and/or Human Interface Devices (HIDs) or other peripheral devices that plug into or otherwise communicate with the host device 105, such as keyboards, mice, screens, touchscreens, tablets, joysticks or other game controllers, webcams, or the like. Further, the embedded system devices 102-104 are configured to communicate with the host device 105 via the OS service interface 108 in order to provide compressed log messages 116 during operation as described herein.

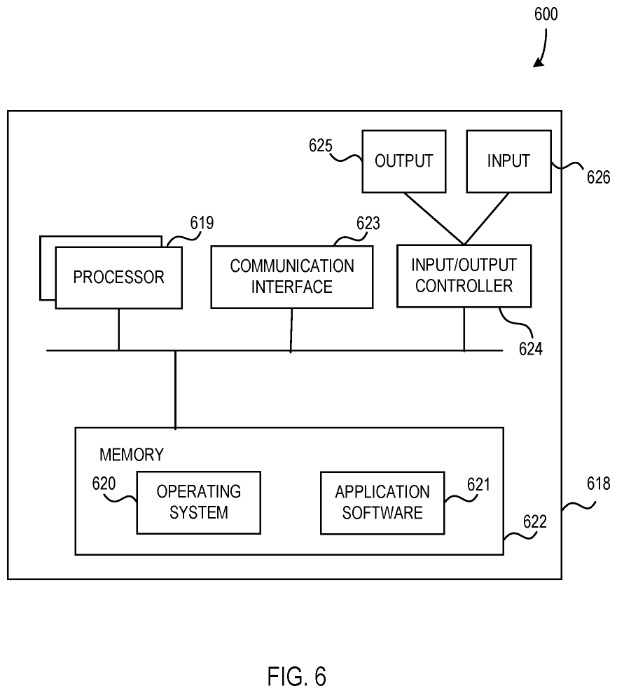

The host device 105 includes hardware, firmware, and/or software configured to execute or otherwise perform operations associated with an OS 106 (e.g., MICROSOFT WINDOWS, a LINUX OS, or the like) and/or an associated OS service interface 108 as described herein. In some examples, the host device 105 comprises a computing device (e.g., a computing apparatus of FIG. 6) such as a personal computer (PC), server device, distributed computing device, mobile device (e.g., a mobile phone or tablet), or the like. In other examples, the host device 105 includes more and/or different types and/or arrangements of computing devices without departing from the description.

Further, in some examples, the embedded system devices 102-104 and the host device 105 are configured to communicate with each other via one or more networks and/or associated network connections. For instance, in some examples, the embedded system device 102 is configured to communicate with the host device 105 via the OS service interface 108 using a BLUETOOTH network connection, while the embedded system device 104 is an HID (e.g., a keyboard, mouse, touchscreen, or the like) configured to communicate with the host device 105 via the OS service interface 108 using a wired network connection. Additionally, or alternatively, embedded system devices 102-104 include devices configured to communicate with the host device 105 via the OS service interface 108 using connections on networks such as private intranets, the Internet, and/or other types of communication networks without departing from the description.

In some examples, the OS 106 of the host device 105 includes system software configured to manage computer hardware, firmware, and/or software resources of the host device 105 and to provide common services to applications and/or computer programs being executed on the host device 105. In some such examples, the services provided include scheduling tasks to be executed using the resources of the host device 105 and logging events and/or log messages associated with the operations of the host device 105 (e.g., debugging log messages, informational log messages, error log messages, warning log messages, or the like). The log messages associated with the OS 106 and that originate from the OS 106 are stored in an OS log 110, including timestamps that reflect the time at which associated events occurred on the host device 105. Such logged information can be used to analyze the operations of the host device 105, to debug the operations of applications on the host device 105, and/or to troubleshoot issues that occur on the host device 105. Additionally, in some examples, the OS log 110 stores log messages from embedded system devices such as embedded system devices 102-104 as described herein, wherein the log messages from those embedded system devices are stored with timestamps that indicate times at which associated events occurred on the embedded system devices. The storage of log messages from the OS 106 and other devices enables the debugging of synchronization issues, such as timing issues, wrong flow issues, or the like, between several connected components (e.g., synchronization between two different touch digitizers, synchronization between a touch digitizer and a pen device, or the like).

Further, in some examples, the host device 105 and OS 106 include an OS service interface 108. The OS service interface 108 is configured to communicate with embedded system devices 102-104 to initiate the log message communication processes described herein. Additionally, or alternatively, the OS service interface 108 is configured to receive and process compressed log messages 124 from embedded system devices 102-104 such that the compressed log messages 124 are converted, using a parser 126, into readable log messages 128 which can then be recorded in the OS log 110. In some such examples, the interactions between the embedded system devices 102-104 and the OS service interface 108 include time synchronization interactions that enable the embedded system devices 102-104 to include timestamps with compressed log messages that are in sync with the clock of the host device 105. These timestamps are then used to write the readable log messages 128 to the OS log 110 in the correct chronological order with respect to the readable log messages 128 from the devices 102-104 and with respect to other log messages that are written to the OS log 110 (e.g., log messages pertaining to the operations of other entities of the OS 106 and/or the host device 105, such as OS drivers and/or other log message sources 134).

In some examples, the OS service interface 108 is configured to receive a logger descriptor 112 from an embedded system device 102 and to store the logger descriptor 112 in a stored set of logger descriptors 118. The OS service interface 108 is further configured to generate a log compression map 120 and a logger filter 122 from the logger descriptor 118. The logger filter 114 generated from the logger descriptor 112 of the embedded system device 102 is provided to the embedded system device 102 to enable the device 102 to generate and send compressed log messages 116 that can be understood and/or processed by the OS service interface 108. This process is described in greater detail below.

Additionally, or alternatively, in some examples, the readable log messages 128 generated by the OS service interface 108 are provided to other entities of the OS 106 and/or host device 105, such as a log Graphical User Interface (GUI) 130 and/or a log file 132 that is specific to an embedded system device 102, specific to a type of embedded system device 102, or otherwise a file that is separate from the OS log 110.

In some examples, a logger descriptor 112 sent by an embedded system device 102 is configured to include data that describes aspects of log messages that are generated and sent by the embedded system device 102. For instance, in some such examples, the logger descriptor 112 includes data describing the following: a protocol version of the device 102, group identifiers of log messages of the device 102, subcomponent identifiers of log messages of the device 102, severity values of log messages of the device 102, output codes of log messages of the device 102, message hash values of log messages of the device 102, text strings of log messages of the device 102, and/or indications of the quantity and types of arguments of log messages of the device 102. Thus, the logger descriptor 112 includes the data and/or information that enables the OS service interface 108 to generate a log compression map 120 that is specific to the log messages of the embedded system device 102 and then to later convert compressed log messages 124 from the device 102 into readable log messages 128. An exemplary logger descriptor 112 or 118 is provided below:

```
<logMessagesFile
        protocol-version=″0x1″
        component-name=″Digitizer-FW″
        hash=″0xAABBCCDD″>
  <groups>
      <group id=″0″ name=″GENERAL″ />
      <group id=″1″ name=″STYLUS″ />
  </groups>
  <severity>
      <level id=″0″ name=″FATAL″ />
      <level id=″1″ name=″ERROR″ />
      <level id=″2″ name=″INFO″ />
  </severity>
  <subcomponents>
      <subcomponent id=″0″ name=″Primary″ />
      <subcomponent id=″1″ name=″Secondary″ />
  </subcomponents>
  <outputs>
      <output id=″0x1″ name=″OS″>
      <output id=″0x2″ name=″Flash″>
      <output id=″0x4″ name=″AuditLog″>
  </outputs>
  <messages>
          <message hash=″0xAB12″ group=″0″ severity=″1″>
            <text>Error occurred - Cycle retry. Cycle number:
%d</text>
          </message>
          <message hash=″0x04AA″ group=″0″ severity=″1″>
            <text>Failed to write flash at address: %d</text>
          </message>
          <message hash=″0x0012″ group=″0″ severity=″2″>
            <text>System state machine was changed to: [%d]
            from: [%d]
(0=A, 1=B, 2=C, 3=D, 4=E, 5=Idle) , CycleNum: %d</text>
          <message hash=″0xC541″ group=″0″ severity=″0″>
            <text>Fatal Error!!! - Config new cycle - last interrupt
has not received wait more than %d micro seconds</text>
          </message>
          <message hash=″0x0101″ group=″0″ severity=″0″>
            <text>Fatal Error!!! Reset System due to consecutive
retries [%d] </text>
          </message>
    </messages>
</logMessagesFile>
```

In the above logger descriptor example, the descriptor 118 is formatted as an Extensible Markup Language (XML) data structure. The structure includes a “logMessagesFile” section that defines the protocol version and the component name associated with the embedded system device 102 from which the descriptor 118 originates. This section further includes a hash value that can be used to compare the descriptor 118 with other descriptors during operations of the OS service interface 108 (e.g., to determine whether the OS service interface 108 already has a particular descriptor 118 stored therein, which enables the OS service interface 108 to skip some initiation operations for devices for which it already has descriptors 118).

Further, the above logger descriptor example includes a “groups” section, a “severity” section, a “subcomponent” section, and an “outputs” section. Each of these sections defines a list of possible data that may be included in log messages received from the source device 102. Group identifiers are used to categorize log messages according to groups that are specifically defined for the device 102 and severity identifiers are used to signal a log message type of a log message, which can be used to sort and/or filter log messages based at least in part on importance or urgency. Subcomponent identifiers can be used if the device 102 includes multiple subcomponents that each generate log messages. Output identifiers can be used to indicate an output source of a log message for devices 102 that have multiple sources from which log messages can be generated and/or sent.

Additionally, the above logger descriptor example includes a “messages” section which includes the text strings for each possible log message, as well as some associated identifiers of each of those log messages. For instance, one of the text strings is “Error occurred—Cycle retry. Cycle number: % d”, which also includes an associated message hash, a group ID of 0 (indicating the “General” group), and a severity ID of 1 (indicating the “ERROR” severity level). The text strings of the messages indicate the text that should be logged in the OS log 110 and/or other log location in order for the log message to be read and understood by a user or other entity. However, as described herein, log messages can be compressed and decompressed using the message hash values and any log compression maps 120 generated by the OS service interface 108.

After receiving a logger descriptor 118 as described herein, the OS interface 108 generates a log compression map 120 that can be applied to or otherwise used with a compressed log message 124 to generate a readable log message 128 with the parser 126. In some examples, the readable log message 128 includes a timestamp of the log message and the text string of the log message with any associated parameter values inserted (e.g., a “% d” character or similar character in a text string of a log message indicates that a specific parameter value should be inserted there, wherein the specific value is also included in the log message). However, the text string of a log message requires a significant amount of space in the log message and the OS service interface 108 already has all of the possible text strings in the stored logger descriptor 118. Thus, the embedded system device 102 is enabled to send compressed log messages 124 that include only a timestamp, a message hash value, and any other values that are to be inserted into the text string of the associated readable log message 128.

In some such examples, the log compression map 120 for the associated embedded system device 102 is configured to map the message hash value to the matching text string. For instance, in the above example, a message hash value of “0xAB12” is mapped to a text string of “Error occurred—Cycle retry. Cycle number: % d”. In such examples, the parser 126 is configured to use the log compression map 120 to determine the text string of the compressed log message 124. Then the parser 126 inserts any parameter values into the text string and includes the timestamp from the compressed log message 124 in the readable log message 128 (e.g., the timestamp is placed at the front of the readable log message 128 or in another location based at least in part on the format of the OS log 110 or other log message destination). Additionally, or alternatively, the compressed log message 124 includes parameter values or other values that are indicative of other aspects of the log message that are not to be inserted into the text string (e.g., a severity level parameter value or a subcomponent ID value). In some such examples, these parameter values are mapped to text values based at least in part on the log compression map 120 and inserted into the readable log message 128 according to the defined format thereof (e.g., a severity level parameter value is translated into an “ERROR” text string and included in the readable log message 128 after the timestamp but before the text string of the log message). The use of the log compression map 120 and associated map entries enables and/or facilitates the accurate interpretation and/or conversion of compressed log messages 124 which, in turn, enables a significant reduction in bandwidth usage and time requirements for an embedded system device 102 to send log messages to the OS service interface 108 over a network connection. This reduction in consumed network resources per sent log message enables the described system to facilitate the sending of more log messages and/or the sending log messages from more embedded system devices than in systems that do not use such compression of log messages.

In some examples, the OS service interface 108 generates logger filters 122 and sends those logger filters to associated embedded system devices 102-104 (e.g., the logger filter 114 sent to the embedded system device 102). A logger filter 122 includes instructions and/or data provided to the embedded system device 102 to enable the device 102 to provide compressed log messages 116 that the OS service interface 108 and/or the OS 106 are expected to receive. For instance, in some examples, the logger filter 122 includes a list or set of severity levels for which the OS service interface 108 is configured to receive log messages from the device 102. (e.g., the logger filter indicates that the device 102 should send log messages of fatal, error, and warning severity levels, resulting in the device 102 sending compressed log messages associated with those security levels but no compressed log messages associated with other security levels). In other examples, the logger filter 122 includes an exclusive list of severity levels, group IDs, or the like that indicate types of log messages that should not be sent. The use of logger filters 122 in this manner enables the OS 106 to configure and/or control the behavior of each embedded system device 102-104 to which the associated OS service interface 108 is connected. The described logger filters 122 enable the OS 106 to define the types of log messages received as well as how those log messages are received in a consistent manner across the multiple embedded system devices 102-104, enabling the OS 106 to process and/or analyze those log messages in an efficient manner as compared to systems that do not enforce such standards on log messages from various connected devices.

Additionally, or alternatively, a logger filter 122 sent to an embedded system device 102 includes information that instructs the device 102 on how to format compressed log messages 124 sent to the OS service interface 108. For instance, in some such examples, the logger filter 122 includes log message formatting information that indicates positions in the log message to insert parameter values, hash values, timestamps, or the like. In such examples, the logger descriptor 118 and associated log compression map 120 are used to determine what parameter values and/or other values are to be included in the compressed log messages 124 and the expected format of those compressed log messages 124 is determined and provided to the associated device 102 in the logger filter 122 for that device 102.

In other examples, more, fewer, or different types of information are included in the logger filter 122 sent to an embedded system device 102 without departing from the description.

In some examples, a compressed log message 124 is generated by an embedded system device 102 in a defined format that can be processed by the OS service interface 108 as described herein. In some such examples, the compressed log message 124 is formatted to include sections of one or more bytes that are assigned to specific portions of the log message 124. For instance, in an example, a compressed log message 124 includes a first section of two bytes that is assigned to the message hash value of the log message 124; a second section of eight bytes that is assigned to a timestamp value; a third section of one byte that is assigned to a subcomponent ID; and a plurality of sections of four bytes each assigned to parameter values of the log message 124. Additionally, or alternatively, such log messages 124 include more, fewer, or different sections without departing from the description (e.g., each log message 124 includes a section assigned to a hash value or other ID value that identifies the device 102 from which the log message 124 originates).

Further, in some examples, a readable log message 128 is generated by the parser 126 based at least in part on a compressed log message 124 and information from the log compression map 120 and/or logger descriptor 118. In some such examples, the readable log message 128 includes a text string that is built using the various values of the compressed log message 124. For instance, in an example, a readable log message 128 includes a first section of the text string for the timestamp; a second section of the text string for device ID of the originating device 102; a third section of the text string for a subcomponent of the device 102; a fourth section of the text string for a severity level value; and a fifth section of the text string for the message text string with inserted parameter values. In other examples, a readable log message 128 includes more, fewer, or different sections arranged in different orders without departing from the description.

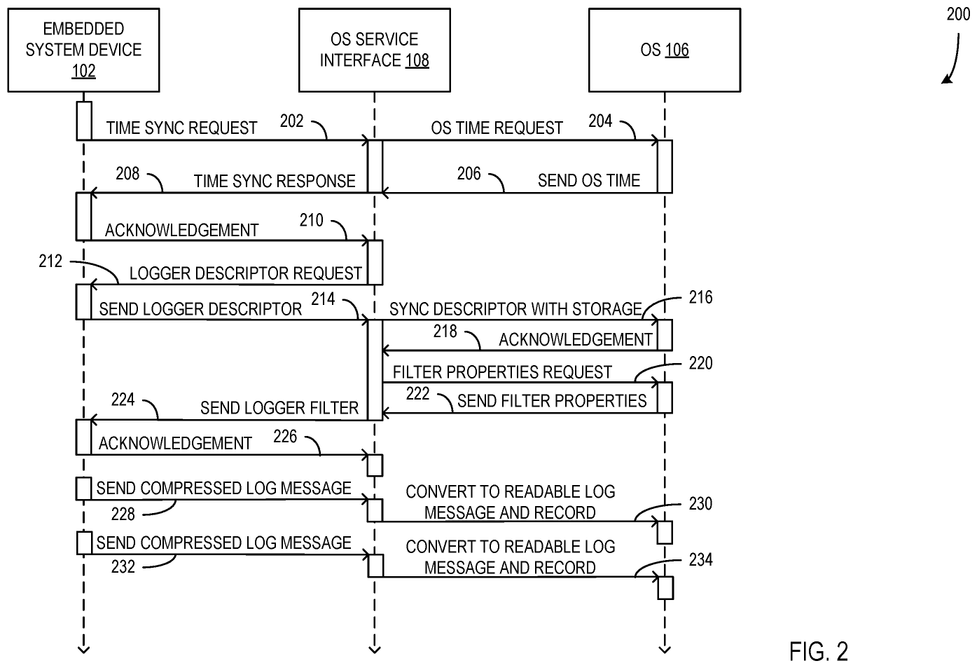

FIG. 2 is a sequence diagram illustrating a process 200 for initializing an embedded system device 102 for sending compressed log messages to an OS 106. In some examples, the process 200 is executed or otherwise performed in a system such as system 100 of FIG. 1.

At 202, the embedded system device 102 sends a time synchronization request, or a time sync request, to the OS service interface 108 associated with the OS 106. In some examples, the embedded system device 102 is configured to automatically send a time sync request to the OS service interface 108 upon becoming connected with the host device 105 with which the OS 106 and interface 108 are associated. For instance, in an example where the embedded system device 102 is connected to a device 105 using a BLUETOOTH network connection, the embedded system device 102 automatically sends a time sync request 202 as part of the connection between the device 102 and the device 105 being formed. Additionally, or alternatively, the embedded system device 102 is configured to periodically send time sync requests to the OS service interface 108 (e.g., every few seconds, every minute, or the like) as described herein in order to maintain a synchronized clock with the OS 106 and to thereby avoid clock drift (e.g., the clocks of the device 102 and the OS 106 may keep time with differing accuracies, resulting in them becoming out of sync over time). The synchronization of the clocks of embedded system devices 102-104 with the clock of an OS 106 using the processing of time sync requests as described herein enables the log messages from the embedded system devices to be provided with timestamps that are synchronized with timestamps of other log messages in the OS log 106. Such synchronization of timestamps enables more accurate analysis to be performed on log messages from different devices with respect to each other, such as analyses for determining the order of different events happen on different devices at similar times. Such analysis enables and/or improves the ability of an analyzer (e.g., an OS-based agent or a user) to, at least, accurately identify timing issues between multiple connected devices.

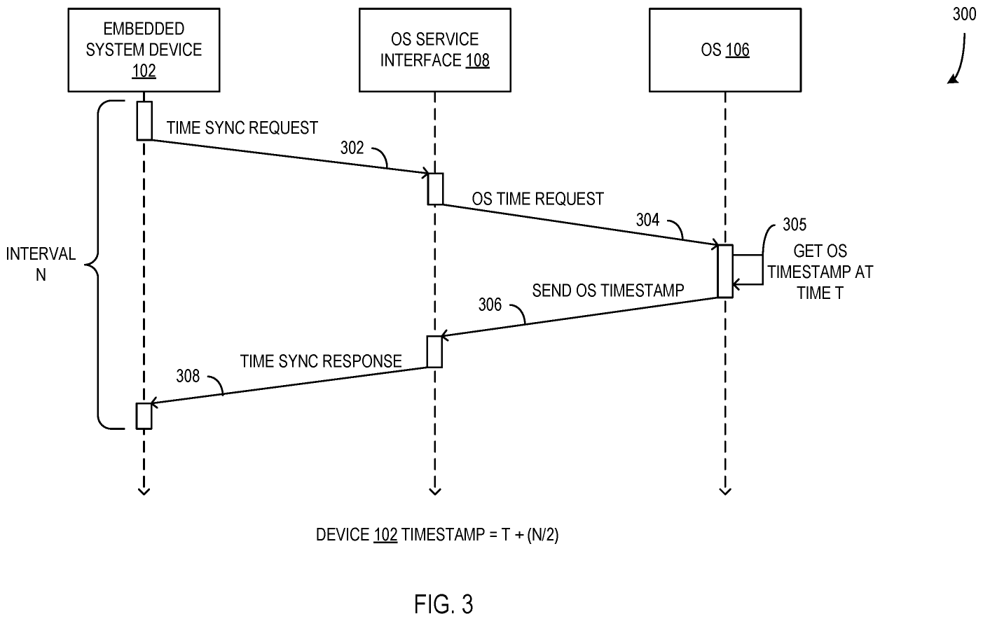

At 204, the OS service interface 108 sends an OS time request to the OS 106 and, at 206, the OS 106 responds by sending the OS time data (e.g., a timestamp indicating the current time as kept by the clock of the OS 106) to the OS service interface 108. The OS service interface 108 responds to the time sync request from the embedded system device 102 at 208 by sending the OS time data to the embedded system device 102. In some such examples, the embedded system device 102 then uses the OS time data to synchronize its own clock to the clock of the OS 106. An example synchronization process is described in greater detail below with respect to FIG. 3.

Further, in some examples, in response to receiving the time sync response at 208, the embedded system device 102 sends an acknowledgement to the time sync response at 210. The OS service interface 108 then continues the initialization process by sending a logger descriptor request at 212. In response to this request, the embedded system device 102 sends a logger descriptor (e.g., logger descriptors 112 and/or 118) at 214.

Upon receiving the logger descriptor from the embedded system device 102, the OS service interface 108 synchronizes the descriptor with storage at 216. In some examples, synchronizing the descriptor with storage includes comparing a hash value and/or other identifier of the descriptor with hash values and/or identifiers of other descriptors that are currently stored by the interface 108 and/or the OS 106. Additionally, or alternatively, in some examples, synchronizing the descriptor with storage includes updating a previously stored descriptor of the device 102 in storage based at least in part on any differences that are present in the descriptor received at 214. At 218, after the synchronization at 216 is complete, the OS 106 acknowledges its completion to the OS service interface 108.

At 220, the OS service interface 108 sends a request for filter properties to the OS 106 and, at 222, the OS 106 responds by sending filter properties to the OS service interface 108. In some examples, the filter properties are used by the OS service interface 108 to generate a logger filter associated with the embedded system device 102. For instance, in some such examples, the filter properties from the OS 106 include property data that indicates the types of log messages and/or the severity levels of log messages that should be sent by the embedded system device 102 and/or other embedded system devices to which the OS 106 connects. Additionally, or alternatively, the filter property data includes data indicating the types of data that should be included in log messages sent by the embedded system device 102. Further, in some examples, the logger filter can be modified and/or updated at the OS 106 and then the updated logger filter sent to the embedded system device 102 as described herein. The embedded system device 102 is then configured to operate according to the updated logger filter. Such modifications can be caused and/or managed by the OS 106, such as during an OS update (e.g., a MICROSOFT WINDOWS update).

At 224, the OS service interface 108 sends a logger filter to the embedded system device 102. In some examples, the logger filter is generated by the OS service interface 108 based, at least in part, on data in the logger descriptor of the device 102 and/or based at least in part on the filter properties sent by the OS 106. At 226, the embedded system device 102 sends an acknowledgement of receiving the sent logger filter, indicating that the embedded system device 102 is ready to begin sending compressed log messages according to the logger filter.

At 228, the embedded system device 102 sends a compressed log message to the OS service interface 108 and, at 230, the OS service interface 108 converts the compressed log message to a readable log message and records to the OS 106 (e.g., the OS log 110). In some examples, the conversion and recording of the log message is performed as described above with respect to FIG. 1. For instance, the conversion of the compressed log message to a readable log message includes comparing a hash value of the compressed log message to entries in a log compression map 120, determining a text string of the log message based at least in part on the comparison, and generating the readable log message using the determined text string and any parameter values inserted therein.

Later, at 232, the embedded system device 102 sends another compressed log message to the OS service interface 108 and, at 234, the OS service interface 108 converts the compressed log message to a readable log message and records it in the same manner as described above with respect to 230. It should be understood that, once the embedded system device 102 and the OS service interface 108 are initialized to enable the embedded system device 102 to send compressed log messages as described herein, the embedded system device 102 can send many compressed log messages over time while the embedded system device 102 operates and is connected to the OS service interface 108. Further, in some examples, OS service interface 108 is configured to resynchronize the clock of the embedded system device 102 periodically during this period and/or to send updated logger filters to the embedded system device 102 to change when and/or how the embedded system device 102 sends compressed log messages during this period.

FIG. 3 is a sequence diagram illustrating a process 300 for synchronizing the clock of an embedded system device 102 with the clock of an OS 106. In some examples, the process 300 is executed or otherwise performed as part of a process such as process 200 of FIG. 2. Further, in some examples, the process 300 is executed or otherwise performed in a system such as system 100 of FIG. 1.

At 302, the time sync request is sent to the OS service interface 108 from the embedded system device 102 and, at 304, the OS time request is sent to the OS 106 from the OS service interface 108, as described above with respect to process 200.

Upon receiving the OS time request, the OS 106 obtains an OS timestamp at a time Tat 305. The OS 106 sends the timestamp T to the OS service interface 108 at 306 and, at 308, the OS service interface 108 sends the timestamp T in a time sync response to the embedded system device 102.

These exchanges between the embedded system device 102, the OS service interface 108, and the OS 106 take an amount of time that results in the timestamp T not being exactly accurate once the embedded system device 102 receives it (e.g., more time has passed since the timestamp T is obtained at the OS 106 during the transfer of the timestamp T to the OS service interface 108 and the embedded system device 102).

In some examples, to control of the time required to obtain the timestamp T from the OS 106, the embedded system device 102 is configured to track the time interval N from when the time sync request is first sent to the OS service interface 108 at 302 to the time when the time sync response is received at 308. This length of time is combined with the timestamp T to obtain a clock setting of the clock of the device 102 that is synchronized with the clock of the OS 106 to a high degree of accuracy. For instance, in some examples, the clock of the device 102 is set to a time of timestamp T plus the half the length of time of interval N (T+(N/2)). This method of timestamp calculation assumes that the communications to the OS 106 at 302 and 304 take substantially the same amount of time as the communications to the embedded system device 102 at 306 and 308, such that half the length of time of interval N has passed since the OS 106 obtained the timestamp T when the device 102 receives the timestamp T at 308.

In other examples, other methods of synchronizing the clock of the embedded system device 102 to the clock of OS 106 without departing from the description.

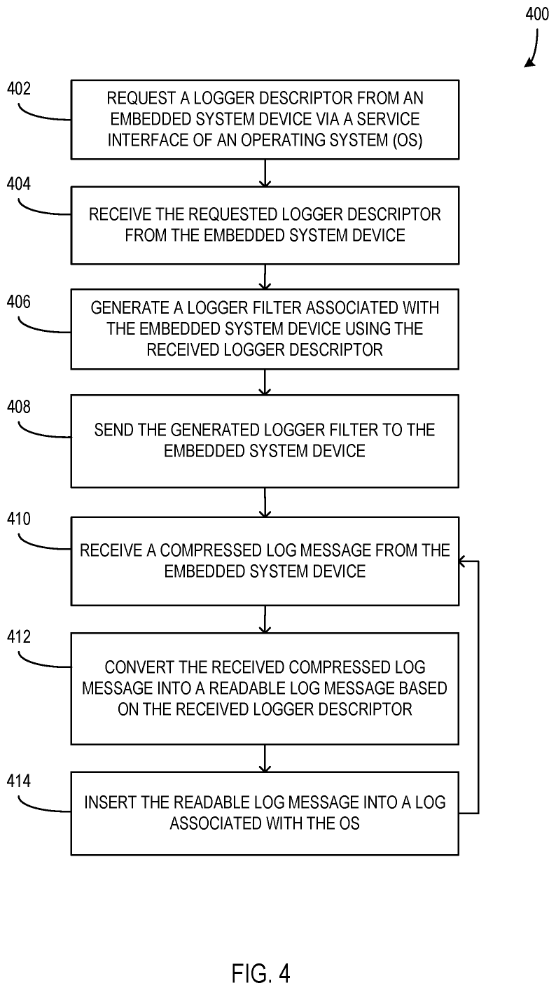

FIG. 4 is a flowchart illustrating a method 400 for initializing an embedded system device 102 for sending compressed log messages 116 and for receiving compressed log messages 116 from the embedded system device 102. In some examples, the method 400 is executed or otherwise performed on a system such as system 100 of FIG. 1.

At 402, a logger descriptor 118 is requested from an embedded system device 102 via a service interface 108 of an OS 106. In some examples, the request for the logger descriptor is preceded by the formation of a connection between the embedded system device and the service interface (e.g., via a BLUETOOTH wireless connection, via a wired connection, or the like). Further, in some such examples, a time synchronization process is performed to synchronize the clock of the embedded system device to the clock of the OS. For instance, in an example, the service interface receives a time sync request from the embedded system device, time data associated with the OS is provided to the embedded system device, and the embedded system device provides an acknowledgement that the clock of the embedded system device is synchronized with the clock of the OS based at least in part on the provided time data. Such time synchronization processes are also performed periodically during the interactions between the embedded system device and the service interface in order to control for any drift of the clock of the embedded system device, in some examples.

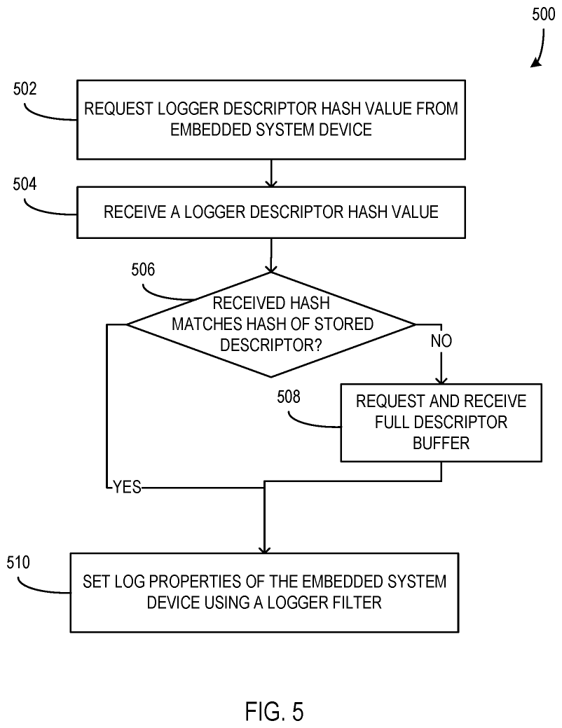

Additionally, or alternatively, in some examples, it is determined whether the service interface has a logger descriptor stored for the embedded system device prior to requesting the logger descriptor from the embedded system device. This process is described in greater detail below with respect to FIG. 5.

At 404, the requested logger descriptor is received from the embedded system device. In some examples, the logger descriptor includes data that is descriptive of possible log messages that are generated by the embedded system device, including data describing the possible log message groups, the possible severity levels, the possible subcomponents from which a log message may originate, the possible text strings of log messages, and/or hash values associated with the text strings. In other examples, more, fewer, or different types of data are included in the logger descriptor without departing from the description.

At 406, a logger filter associated with the embedded system device is generated using the received logger descriptor and, at 408, the generated logger filter is sent to the embedded system device. In some examples, the generated logger filter includes data that is indicative of how compressed log messages from the embedded system device should be structured such that they can be converted or otherwise processed by the service interface. Further, the generated logger filter includes an allowed list indicating the types of log messages that should be sent by the embedded system device (e.g., allowed severity levels, allowed message groups, allowed subcomponents, or the like) and/or a blocked list indicating the types of log messages that should not be sent by the embedded system device (e.g., blocked severity levels, blocked message groups, blocked subcomponents, or the like).

Additionally, or alternatively, in some examples, the logger filter is updated to reflect changes made to the types of log messages that should or should not be sent by the embedded system device to the service interface of the OS. In such examples, the updated logger filter is then sent to the embedded system device, which is configured to replace the old logger filter with the updated logger filter and to change its log message sending behavior to reflect the changes in the updated logger filter (e.g., a logger filter update that expands the allowed list of log messages to include log messages of a “DEBUG” severity level results in the embedded system device being reconfigured to send log messages of “DEBUG” severity level in addition to any other types of log messages that were already listed in the allowed list).

At 410, a compressed log message is received from the embedded system device. In some examples, the compressed log message include data formatted based at least in part on the logger filter sent to the embedded system device. Further, in some examples, the compressed log message includes at least one of the following: a timestamp, a hash value, and/or a parameter value or values associated with the log message. Because the log message is compressed, it does not include the text string of the log message, which tend to occupy relatively large portions of log messages, generally.

At 412, the received compressed log message is converted into a readable log message based at least in part on the received logger descriptor and, at 414, the readable log message is inserted into a log associated with the OS. In some examples, the conversion of the readable log message into a readable log message is performed based at least in part on a log compression map that has been generated from the logger descriptor of the embedded system device as described herein (e.g., the log compression map includes a map entry that maps a log message hash value to a log message text string and/or a map entry that maps a log message hash value and compressed log message section value to a parameter data value associated with a log message text string). For instance, in an example, a hash value of the compressed log message is used with the log compression map to identify a text string of the readable log message and then, any parameter values included in the compressed log message are inserted into the corresponding locations in the text string of the readable log message.

Further, in some examples, the service interface of the OS receives compressed log messages from multiple embedded system devices during a time period. Each compressed log message is converted to a readable log message using the corresponding logger descriptor and/or log compression map of the source embedded system device. Those readable log messages are then recorded in the log associated with the OS (e.g., the OS log 110), such that they are recorded in the same log in an order based at least in part on timestamps included with the log messages. Because each of the embedded system devices is synchronized with the clock of the OS within a certain degree of error, the log messages from the multiple embedded system devices can be recorded together in the same log accurately. Additionally, in some examples, the log further includes log messages from the OS and/or other entities associated with the OS (e.g., OS drivers and/or log message sources 134), such that interactions between such entities and embedded system devices can be observed through the log messages recorded in the log. The accurate, synchronized logging from embedded system devices and the OS in a combined log enables efficient analysis of the operations of those devices and the OS with respect to one another and facilitates identification of timing issues between those devices and the OS.

FIG. 5 is a flowchart illustrating a method 500 for initializing an embedded system device 102 for sending compressed log messages 116 based at least in part on whether a logger descriptor 118 has already been received from the embedded system device 102. In some examples, the method 400 is executed or otherwise performed on a system such as system 100 of FIG. 1. Further, in some examples, the method 500 is performed as a part of a method such as method 400.

At 502, a logger descriptor hash value is requested from an embedded system device. In some examples, this request is triggered by an embedded system device becoming connected to the OS service interface of an OS. Such connection formation includes initial connection formation between the two entities, reconnection between the entities as a result of temporary failure of a connection, or the like.

At 504, a logger descriptor hash value is received from the embedded system device. In some examples, the logger descriptor hash value is generated from the logger descriptor of the embedded system device using a defined hash value calculation process. As a result of this process, the logger descriptor hash value occupies substantially less data storage space than the logger descriptor itself while being a sufficiently unique identifier of the logger descriptor among possible logger descriptors of embedded system devices. Additionally, the logger descriptor hash value requires significantly less bandwidth usage to send between the embedded system devices and the OS service interface, reducing the total bandwidth used during instances where a matching logger descriptor is already stored by or in association with the OS service interface.

At 506, if the received hash value matches a hash of a stored logger descriptor, the process proceeds to 510. Alternatively, if the received hash value does not match a hash of a stored logger descriptor, the process proceeds to 508. In examples where the matching hash is identified among the stored logger descriptors, requesting and receiving of the logger descriptor from the embedded system device can be avoided, which is relatively expensive in terms of bandwidth compared to obtaining the logger descriptor hash values.

At 508, a full logger descriptor buffer is requested and received from the embedded system device and the process proceeds to 510.

At 510, the log properties of the embedded system device are set using a logger filter as described previously herein (e.g., generating the logger filter at 406 and sending the logger filter at 408 of method 400).

It should be understood that, by first checking for the presence of a logger descriptor in storage based at least in part on a received logger descriptor hash value before requesting a logger descriptor from an embedded system device, the initialization process for the embedded system device can be streamlined, reducing the time required and the bandwidth required for doing so.

### Exemplary Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hardcoded machine. In some examples, platform software comprising an operating system 620 or any other suitable platform software is provided on the apparatus 618 to enable application software 621 to be executed on the device. In some examples, initializing embedded system devices to send compressed log messages to a host device and then receiving and recording log messages from initialized embedded system devices as described herein is accomplished by software, hardware, and/or firmware.

In some examples, computer executable instructions are provided using any computer-readable media that are accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receive output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises: at least one processor; and at least one memory comprising computer program code, the at least one memory and the computer program code configured to, with the at least one processor, cause the at least one processor to: request a logger descriptor from an embedded system device via a service interface of an Operating System (OS); receive the requested logger descriptor from the embedded system device, wherein the logger descriptor includes at least one of the following: log message severity level values, log message group values, log message text strings, and log message hash values; generate a logger filter associated with the embedded system device using the received logger descriptor; send the generated logger filter to the embedded system device; receive a compressed log message from the embedded system device, wherein the compressed log message is compressed based at least in part on the logger filter; convert the received compressed log message into a readable log message based at least in part on the received logger descriptor; and insert the readable log message into a log associated with the OS.

An example computerized method comprises: requesting, by a processor, a logger descriptor from an embedded system device via a service interface of an Operating System (OS); receiving, by the processor, the requested logger descriptor from the embedded system device, wherein the logger descriptor includes at least one of the following: log message severity level values, log message group values, log message text strings, and log message hash values; generating, by the processor, a logger filter associated with the embedded system device using the received logger descriptor; sending, by the processor, the generated logger filter to the embedded system device; receiving, by the processor, a compressed log message from the embedded system device, wherein the compressed log message is compressed based at least in part on the logger filter; converting, by the processor, the received compressed log message into a readable log message based at least in part on the received logger descriptor; and inserting, by the processor, the readable log message into a log associated with the OS.

One or more computer storage media having computer-executable instructions that, upon execution by a processor, cause the processor to at least: request a logger descriptor from an embedded system device via a service interface of an Operating System (OS); receive the requested logger descriptor from the embedded system device, wherein the logger descriptor includes at least one of the following: log message severity level values, log message group values, log message text strings, and log message hash values; generate a logger filter associated with the embedded system device using the received logger descriptor; send the generated logger filter to the embedded system device; receive a compressed log message from the embedded system device, wherein the compressed log message is compressed based at least in part on the logger filter; convert the received compressed log message into a readable log message based at least in part on the received logger descriptor; and insert the readable log message into a log associated with the OS.

Alternatively, or in addition to the other examples described herein, examples include any combination of the following:
further comprising: receiving a time sync request from the embedded system device; providing time data associated with the OS to the embedded system device, wherein the embedded system device is enabled to synchronize with the OS using the provided time data; and receiving a time sync acknowledgement from the embedded system device, wherein requesting the logger descriptor is triggered based at least in part on receiving the time sync acknowledgement.
further comprising providing additional time data associated with the OS to the embedded system device periodically, wherein the embedded system device is enabled to resynchronize with the OS using the provided additional time data.
further comprising: generating a log compression map from the received logger descriptor, wherein the log compression map includes at least one of the following: a map entry that maps a log message hash value to a log message text string and a map entry that maps a log message hash value and a compressed log message section value to a parameter data value associated with a log message text string; and wherein converting the received compressed log message into a readable log message based at least in part on the received logger descriptor further includes converting the received compressed log message into a readable log message based at least in part on the generated log compression map.
further comprising: detecting formation of a connection between a second embedded system device and the service interface of the OS; obtaining a logger descriptor hash value from the second embedded system device; matching the obtained logger descriptor hash value of the second embedded system device to a logger descriptor hash value stored in association with the service interface; based at least in part on the match, generating a second logger filter associated with the second embedded system device using a stored logger descriptor associated with the stored logger descriptor hash value and the second embedded system device; and sending the generated second logger filter to the second embedded system device, whereby requesting a logger descriptor from the second embedded system device is avoided.
further comprising: receiving a second compressed log message from the second embedded system device; converting the received second compressed log message into a second readable log message based at least in part on the stored logger descriptor associated with the stored logger descriptor hash value and the second embedded system device; and inserting the second readable log message into the log associated with the OS, wherein the readable log message and the second readable log message are inserted into the same log in an order based at least in part on associated timestamps of the readable log message and the second readable log message.
wherein generating the logger filter includes a set of severity level values, wherein the logger filter instructs the embedded system device to send compressed log messages associated with at least one severity level value of the set of severity level values; wherein the compressed log message includes data indicating a severity level value of the set of severity level values in the logger filter.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for requesting, by a processor, a logger descriptor from an embedded system device via a service interface of an Operating System (OS); an exemplary means for receiving, by the processor, the requested logger descriptor from the embedded system device, wherein the logger descriptor includes at least one of the following: log message severity level values, log message group values, log message text strings, and log message hash values; an exemplary means for generating, by the processor, a logger filter associated with the embedded system device using the received logger descriptor; an exemplary means for sending, by the processor, the generated logger filter to the embedded system device; an exemplary means for receiving, by the processor, a compressed log message from the embedded system device, wherein the compressed log message is compressed based at least in part on the logger filter; an exemplary means for converting, by the processor, the received compressed log message into a readable log message based at least in part on the received logger descriptor; and an exemplary means for inserting, by the processor, the readable log message into a log associated with the OS.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
at least one processor; and
at least one memory comprising computer program code, the at least one memory and the computer program code configured to, with the at least one processor, cause the at least one processor to:
request a logger descriptor from an embedded system device via a service interface of an Operating System (OS);
receive the requested logger descriptor from the embedded system device, wherein the logger descriptor includes at least one of the following: log message severity level values, log message group values, log message text strings, and log message hash values;
generate a logger filter associated with the embedded system device using the received logger descriptor;
send the generated logger filter to the embedded system device;
receive a compressed log message from the embedded system device, wherein the compressed log message is compressed based at least in part on the logger filter;
convert the received compressed log message into a readable log message based at least in part on the received logger descriptor; and
insert the readable log message into a log associated with the OS.

2. The system of claim 1, wherein the at least one memory and the computer program code are configured to, with the at least one processor, further cause the at least one processor to:
receive a time sync request from the embedded system device;
provide time data associated with the OS to the embedded system device, wherein the embedded system device is enabled to synchronize with the OS using the provided time data; and
receive a time sync acknowledgement from the embedded system device, wherein requesting the logger descriptor is triggered based at least in part on receiving the time sync acknowledgement.

3. The system of claim 2, wherein the at least one memory and the computer program code are configured to, with the at least one processor, further cause the at least one processor to provide additional time data associated with the OS to the embedded system device periodically, wherein the embedded system device is enabled to resynchronize with the OS using the provided additional time data.

4. The system of claim 1, wherein the at least one memory and the computer program code are configured to, with the at least one processor, further cause the at least one processor to:
generate a log compression map from the received logger descriptor, wherein the log compression map includes at least one of the following: a map entry that maps a log message hash value to a log message text string and a map entry that maps a log message hash value and a compressed log message section value to a parameter data value associated with a log message text string; and
wherein converting the received compressed log message into a readable log message based at least in part on the received logger descriptor further includes converting the received compressed log message into a readable log message based at least in part on the generated log compression map.

5. The system of claim 1, wherein the at least one memory and the computer program code are configured to, with the at least one processor, further cause the at least one processor to:
detect formation of a connection between a second embedded system device and the service interface of the OS;
obtain a logger descriptor hash value from the second embedded system device;
match the obtained logger descriptor hash value of the second embedded system device to a logger descriptor hash value stored in association with the service interface;
based at least in part on the match, generate a second logger filter associated with the second embedded system device using a stored logger descriptor associated with the stored logger descriptor hash value and the second embedded system device; and
send the generated second logger filter to the second embedded system device, whereby requesting a logger descriptor from the second embedded system device is avoided.

6. The system of claim 5, wherein the at least one memory and the computer program code are configured to, with the at least one processor, further cause the at least one processor to:
receive a second compressed log message from the second embedded system device;
convert the received second compressed log message into a second readable log message based at least in part on the stored logger descriptor associated with the stored logger descriptor hash value and the second embedded system device; and
insert the second readable log message into the log associated with the OS, wherein the readable log message and the second readable log message are inserted into the same log in an order based at least in part on associated timestamps of the readable log message and the second readable log message.

7. The system of claim 1, wherein generating the logger filter includes a set of severity level values, wherein the logger filter instructs the embedded system device to send compressed log messages associated with at least one severity level value of the set of severity level values;
wherein the compressed log message includes data indicating a severity level value of the set of severity level values in the logger filter.

8. A computerized method comprising:
requesting, by a processor, a logger descriptor from an embedded system device via a service interface of an Operating System (OS);
receiving, by the processor, the requested logger descriptor from the embedded system device, wherein the logger descriptor includes at least one of the following: log message severity level values, log message group values, log message text strings, and log message hash values;
generating, by the processor, a logger filter associated with the embedded system device using the received logger descriptor;
sending, by the processor, the generated logger filter to the embedded system device;
receiving, by the processor, a compressed log message from the embedded system device, wherein the compressed log message is compressed based at least in part on the logger filter;
converting, by the processor, the received compressed log message into a readable log message based at least in part on the received logger descriptor; and
inserting, by the processor, the readable log message into a log associated with the OS.

9. The computerized method of claim 8, further comprising:
receiving a time sync request from the embedded system device;
providing time data associated with the OS to the embedded system device, wherein the embedded system device is enabled to synchronize with the OS using the provided time data; and
receiving a time sync acknowledgement from the embedded system device, wherein requesting the logger descriptor is triggered based at least in part on receiving the time sync acknowledgement.

10. The computerized method of claim 9, further comprising providing additional time data associated with the OS to the embedded system device periodically, wherein the embedded system device is enabled to resynchronize with the OS using the provided additional time data.

11. The computerized method of claim 8, further comprising:
generating a log compression map from the received logger descriptor, wherein the log compression map includes at least one of the following: a map entry that maps a log message hash value to a log message text string and a map entry that maps a log message hash value and a compressed log message section value to a parameter data value associated with a log message text string; and
wherein converting the received compressed log message into a readable log message based at least in part on the received logger descriptor further includes converting the received compressed log message into a readable log message based at least in part on the generated log compression map.

12. The computerized method of claim 8, further comprising:
detecting formation of a connection between a second embedded system device and the service interface of the OS;
obtaining a logger descriptor hash value from the second embedded system device;
matching the obtained logger descriptor hash value of the second embedded system device to a logger descriptor hash value stored in association with the service interface;
based at least in part on the match, generating a second logger filter associated with the second embedded system device using a stored logger descriptor associated with the stored logger descriptor hash value and the second embedded system device; and
sending the generated second logger filter to the second embedded system device, whereby requesting a logger descriptor from the second embedded system device is avoided.

13. The computerized method of claim 12, further comprising:
receiving a second compressed log message from the second embedded system device;
converting the received second compressed log message into a second readable log message based at least in part on the stored logger descriptor associated with the stored logger descriptor hash value and the second embedded system device; and
inserting the second readable log message into the log associated with the OS, wherein the readable log message and the second readable log message are inserted into the same log in an order based at least in part on associated timestamps of the readable log message and the second readable log message.

14. The computerized method of claim 8, wherein generating the logger filter includes a set of severity level values, wherein the logger filter instructs the embedded system device to send compressed log messages associated with at least one severity level value of the set of severity level values;
wherein the compressed log message includes data indicating a severity level value of the set of severity level values in the logger filter.

15. One or more computer storage media having computer-executable instructions that, upon execution by a processor, cause the processor to at least:
request a logger descriptor from an embedded system device via a service interface of an Operating System (OS);
receive the requested logger descriptor from the embedded system device, wherein the logger descriptor includes at least one of the following: log message severity level values, log message group values, log message text strings, and log message hash values;
generate a logger filter associated with the embedded system device using the received logger descriptor;
send the generated logger filter to the embedded system device;
receive a compressed log message from the embedded system device, wherein the compressed log message is compressed based at least in part on the logger filter;
convert the received compressed log message into a readable log message based at least in part on the received logger descriptor; and
insert the readable log message into a log associated with the OS.

16. The one or more computer storage media of claim 15, wherein the computer-executable instructions, upon execution by a processor, further cause the processor to at least:
receive a time sync request from the embedded system device;
provide time data associated with the OS to the embedded system device, wherein the embedded system device is enabled to synchronize with the OS using the provided time data; and
receive a time sync acknowledgement from the embedded system device, wherein requesting the logger descriptor is triggered based at least in part on receiving the time sync acknowledgement.

17. The one or more computer storage media of claim 16, wherein the computer-executable instructions, upon execution by a processor, further cause the processor to at least provide additional time data associated with the OS to the embedded system device periodically, wherein the embedded system device is enabled to resynchronize with the OS using the provided additional time data.

18. The one or more computer storage media of claim 15, wherein the computer-executable instructions, upon execution by a processor, further cause the processor to at least:
generate a log compression map from the received logger descriptor, wherein the log compression map includes at least one of the following: a map entry that maps a log message hash value to a log message text string and a map entry that maps a log message hash value and a compressed log message section value to a parameter data value associated with a log message text string; and
wherein converting the received compressed log message into a readable log message based at least in part on the received logger descriptor further includes converting the received compressed log message into a readable log message based at least in part on the generated log compression map.

19. The one or more computer storage media of claim 15, wherein the computer-executable instructions, upon execution by a processor, further cause the processor to at least:
detect formation of a connection between a second embedded system device and the service interface of the OS;
obtain a logger descriptor hash value from the second embedded system device;
match the obtained logger descriptor hash value of the second embedded system device to a logger descriptor hash value stored in association with the service interface;
based at least in part on the match, generate a second logger filter associated with the second embedded system device using a stored logger descriptor associated with the stored logger descriptor hash value and the second embedded system device; and
send the generated second logger filter to the second embedded system device, whereby requesting a logger descriptor from the second embedded system device is avoided.

20. The one or more computer storage media of claim 19, wherein the computer-executable instructions, upon execution by a processor, further cause the processor to at least:
receive a second compressed log message from the second embedded system device;
convert the received second compressed log message into a second readable log message based at least in part on the stored logger descriptor associated with the stored logger descriptor hash value and the second embedded system device; and
insert the second readable log message into the log associated with the OS, wherein the readable log message and the second readable log message are inserted into the same log in an order based at least in part on associated timestamps of the readable log message and the second readable log message.
